(19) United States
(12) Patent Application Publication
(10) Pub. No.: US 2002/0135831 A1
(43) Pub. Date: Sep. 26, 2002

(54) Anamorphic optical collimator for laser diode

(76) Inventor: KiSoo Park, Kyungki-Do (KR)

Correspondence Address: KISOO PARK, C/O HWAN KIM, ESQ., O'MELVENY & MYERS LLP, 1650 TYSONS BOULEVARD, SUITE 1150, MCLEAN, VA, 22102, US

(21) Appl. No.: 09/816,953

(22) Filed: Mar. 23, 2001

(51) Int. Cl. G02B 5/32

(52) U.S. Cl. 359/19; 359/27

(57) ABSTRACT

An anamorphic optical collimator for laser diode having 5-lens elements of positive, positive, negative, positive, and positive optical power and designed to have an input aperture angle of up to ±22° in its meridianal section and up to ±6° in its sagittal section, large exit pupil, anamorphic coefficient equal to 4, angular divergence of collimated beam not exceeding 1 mrad, and the possibility of independently adjusting the angular divergences of the exit laser beam in the meridianal and sagittal planes of the optical collimator. The optical collimator comprises a first positive spherical lens element of a meniscus shape with its concave surface faced to laser diode, a second positive spherical lens element of a plane-convex shape, a third negative cylindrical lens element of a plane-concave shape, a fourth positive cylindrical lens element of a plane-convex shape, and a fifth positive lens element of a spherical plane-convex shape. The first three lens elements are mounted in a housing that may move along and rotate about the collimator's optical axis. This rotation allows the third lens element to rotate relative to the fourth lens element such that the angular divergence of the exit laser beam with respect to its meridianal and sagittal planes of the collimator may be independently adjusted. The exit pupil size of the optical collimator is chosen so as to provide a safe operating range of optical power densities with respect to the human eyes in cases of ocular exposure, even when the laser diode generates a beam with laser power as high as 100 mW. Furthermore, the optical collimator of the present invention minimizes beam aberration as much as possible while providing a collimated beam with an angular divergence of less than 1 mrad.

### FIELD OF THE INVENTION

The invention relates generally to optical collimators for expanding and collimating laser diode radiation, and more particularly, to a laser diode beam collimator for use in a wireless optical data communication system. The subject collimator can also be used in range finders, laser simulation systems, and laser-optical games where laser beams must be transmitted within a narrow physical band without much angular divergence and safely without causing eye injuries even in the event of direct human ocular exposure.

### BACKGROUND OF THE INVENTION

A laser diode is currently the most popular light source for optical communication systems because of its narrow spectral bandwidth of radiation, high optical power, high speed modulation possibility, simple current modulation, low cost, high reliability, etc. Laser diodes are mostly used in optical-electronic devices and systems where access to laser beams is quite restricted and beam transmission is enclosed within a sealed environment (e.g., optical fiber communication systems, CD-ROM, DVD drivers, etc.). Recently, however, laser diodes have been utilized in more “open” applications such as high-speed free space and wireless optical data communication networks, range finders, laser optical markers, and various laser simulation games where laser beams travel outside the strict confines of an enclosed environment. For these “open” applications, it is necessary to utilize narrow laser beams with low angular divergence during its transmission.

Companies are currently attempting to use the most powerful laser diodes available, since increasing power extends the available range of a given communication network and improves its overall reliability wherever lasers are used within the system. However, in applications where ground or other near surface transmission of laser beams is necessary, there exists a possibility of accidental human ocular exposure and subsequent eye injury. In addition, serious risks of eye injury exist to personnel during the manufacturing, aligning, and testing processes of systems utilizing the laser technology. Several country standards have established guidelines for safe laser usage. One example of such a standard is the American National Standard for Safe Use of Laser (ANSI Z136.1-1993). Within a given standard, there are estimated conditions and specifications for safe laser usage. Given these specifications, for the most part, the usual method of achieving laser power densities safe enough for various applications requires reducing the total laser beam power to an amount that may not be appropriate for many applications.

Using a laser diode poses other problems such as non-uniform angular intensity distribution and astigmatism of the emitted beam. It is well known that laser beams emitted from a laser diode possess an elliptical shape. The collimated beam will follow this elliptical shape for a long distance and therefore will not fully utilize the entire light area of the lens. Consequently, the resulting laser beam does not possess as much power density in its illumination area as it would if it were propagated with a circular shape. In addition, this type of narrow power density distribution attributable to the elliptical shape of the laser beam increases the danger of using such a beam in various applications. Although a narrower laser beam with an elliptical shape possesses a weaker power density at a distance far away from the collimator, it has a higher power density immediately after passing through the collimating lens. Thus, such higher power density increases risk of eye injuries resulting from accidental exposure. Furthermore, for narrow beams, the statistical performance of transmission and reception of optical signal beams is heavily dependent upon atmospheric conditions. Narrows beams are quite easily affected by atmospheric elements such as rain drops, snow particles, etc. Therefore, in wireless communication systems, the use of narrow beams increases the level of error in the transmission of data.

Since the introduction of such errors during beam transmission causes serious problems in most laser diode applications (in addition to those present in wireless optical communication systems), several solutions have been developed in an attempt to deal with these problems. Yoshifumi Adachi disclosed in U.S. Pat. No. 5,321,717 an anamorphic laser collimator with two-prisms. By definition, anamorphic means that a system has different magnification in its meridianal and sagittal sections. FIGS. 1 and 2 illustrate a sample prior art laser collimator having a two-prism shaper 8 in its meridianal and sagittal sections, respectively. Similar to most other optical prism systems, the prism shaper works well with parallel beams. As shown in FIG. 1, a collimated laser beam 10 approaches prism 12 that has a verge angle α. The system 8 changes the dimensions of the laser beam in its meridianal section. The magnification value is equal to the ratio of output to input beam width values, namely Sₒ/Sᵢ. Similarly, demagnification is possible as long as the optical beam 10 approaches prism 12 from the opposite side. The magnification (demagnification) value is dependent on the index of refraction, “n”, of the prism material and the values of angles α and θᵢ. The incidence angle θᵢ is chosen according to the shaper requirements (as will be explained later) but usually the angle is chosen to be equal to or close to the Brewster angle for minimizing the optical reflection from the front surfaces of prisms 12 and 14:

tan θᵢ=n (1)

The incidence angles θᵢ are the same for both prisms 12 and 14, because only in this case will the output beam be parallel to the input beam. The angle of the laser beam incident to the exit surfaces of the prisms is usually chosen to be equal to 0° since such an angle allows the greatest expansion of the laser beam (Sₒ has the maximal size in this case). Also, the greater the angle of θᵢ, the greater the expansion of the emitted beam. Therefore, given these characteristics, the prism with the maximal index of refraction is preferred. It is easy to see that expanding the magnification value equals:

Sₒ/Sᵢ=2x(Sᵢ/cosθᵢ)/Sᵢ=2/cos θᵢ (2)

Given that Sₒ/Sᵢ =2/cos θᵢ from equation (2), if the index of refraction of a given prism material is n=1.732, then θᵢ=arctan 1.732=60°, cos 60°=0.5, and therefore Sₒ/Sᵢ =4.

At the same time, prisms 12 and 14 do not change beam dimensions in the sagittal planes as depicted in FIG. 2 (Sᵢ=Sₒ). This means that a laser collimator system having a two-prism shaper can improve the shape of the output laser diode beam by transforming an elliptical input beam to a circular output beam. Because of this transformation capability, anamorphic laser collimators are most widely used in wireless communication systems. The results of optical calculations for the given example of a two-prism shaper are shown in FIGS. 3A-3C. The calculation is based on the values of α=30°, prisms made of glass with its index of refraction n=1.73 (for designed wavelength 0.8 μm), and θᵢ chosen to equal 60°. The shadow zones of FIGS. 3A, 3B, and 3C show the shapes of the initial input, intermediate, and output laser beams, respectively. A serious drawback nevertheless exists in that, within the prism shaper, the optical axis of the beam does not form one continuous line. Instead, there is a break in the optical axis as the output beam is shifted several millimeters with respect to the input beam by a value of “h” as indicated in FIG. 1. This shift creates some problems during the system manufacturing and aligning processes. More specifically, such a “broken” optical axis makes it extremely difficult to optically align the system in any application requiring symmetrical prism positioning.

Furthermore, anamorphic laser collimators embody several serious disadvantages such as power loss, higher-than-safe levels of optical power density, and complexity of design. Anti-reflective (AR) coatings that are applied to the output surfaces of the prisms as explained in U.S. Pat. No. 5,321,717 lead to unacceptable amounts of power loss. It is well known that high quality interference coatings are very sensitive to the angle of beam incidence. Optical reflections from the front surfaces of the prisms also depend on the orientation of the polarization vector with respect to the beam incidence plane. As such, the minimal reflection according to the Brewster effect (for P-polarization) is unable to be exactly met because the laser diode beam does not possess exact linear polarization. Thus, after the occurrence of reflections at the prism surfaces, real optical power loss amounts to about 30%˜50%. [see Power Technology Inc. Co., Product Selection Catalog No PMC-1096 “Laser Diode Systems and Components”, p. 7]. Higher-than-acceptable optical power density levels also cause problems in prior art collimators. In a typical prior art anamorphic collimator, the size of the output beam is typically only about 1 mm wide. Thus, the optical power density (i.e., power/size ratio of the illuminating area) is much too high, even if the laser power reaches a mere 1 mW. Such a high optical power density poses serious risks for human eyes in the case of accidental ocular exposure.

In addition to power loss and higher-than-desired levels of optical power density, prior art anamorphic collimators are complex in design. Since a two-prism shaper can only work properly with collimated beams, the laser collimator requires at least one additional collimating lens that is installed between a laser diode and the two prism shaper. However, usually three additional lenses are preferred: one lens for collimating a beam emitted from a laser diode and two more lenses for expanding the beam. Thus, in total, an anamorphic collimator comprises of at least five different optical elements including: a collimating lens; two-prisms for shaping the beam; and two lenses of a telescope for beam expansion/reduction. This type of system is described in U.S. Pat. No. 5,321,717. An example of such an optical layout of a laser collimator is shown in FIGS. 4A and 4B, meridianal and sagittal sections, respectively. In the anamorphic collimator 40, the lens 44 collimates the laser beam being emitted from laser diode 42. Prisms 12 and 14 shape the beam and lenses 46 and 48 combine the telescopic expander of the laser beam.

In the collimator 40 as depicted in FIGS. 4A and 4B, there is also a stringent aberration requirement for the first set of lenses because the prisms can only work properly with a well collimated beam. Furthermore, since the collimator 40 cannot correct laser beam astigmatism, the output beam has different focal planes in its meridianal and sagittal sections and is too difficult to transform into a circularly shaped illuminating spot suitable for a wireless communication system. Usually, one additional optical component (e.g., cylindrical lens, glass plate, etc.) is necessary to correct the laser beam astigmatism.

Another serious problem associated with prior art laser collimators is the astigmatic aberration of the emitted laser beam. With the exception of the new surface-emitting laser diodes, it is well known that current laser diodes emit astigmatic beams. This type of beam aberration is related to the shapes of the laser resonators. Astigmatic aberration is a serious drawback of the laser diodes because astigmatism destroys the performance of focusing the laser beam after its collimation. As shown in FIG. 5, a laser diode 42 has active layer 54 with an exit window in the shape of a slit (not shown). The emitting beam passing through the exit window is an astigmatic one, because it can be considered as being emitted from two different point sources A and B and distanced by as much as ΔZ_{L}. Next, collimating optics are depicted in FIG. 5 as a single equivalent lens 56 that magnifies the laser beam and forms two different focal lines F_{A} and F_{B}. Those two focal lines, F_{A} and F_{B}, are the images of the point sources, A and B, respectively. The astigmatic distance ΔZ_{L} between these images equals ΔZ_{L}×M², where M is the lateral magnification of the collimator. There is also a focusing circle 58 where the laser beam is best focused.

As shown in FIG. 5, the original astigmatism of a laser beam takes place if a wave front of an optical beam has a different curvature in its meridianal and sagittal sections. The simplest way of dealing with and correcting this type of astigmatism is to use an additional cylindrical lens that can trim beam divergences in both sections. However, even within the same type, each individual laser diode possesses a different astigmatic characteristic, and oftentimes, the astigmatism cannot be completely removed. Therefore, it is necessary to use different cylindrical lenses having different optical power (1/F), where F is the focal distance of the lens.

Tsutomu Matsui discovered another way of correcting the astigmatism present in laser beams as described in U.S. Pat. Nos. 6,094,406 and 5,978,345. The optical component (i.e., cylindrical lens or glass plate) producing the initial astigmatism can change its laser astigmatic performance if its position next to the laser diode is slightly tilted about the optical axis of the collimator. Tilting a cylindrical lens with respect to the optical axis of the collimator will introduce variable astigmatism aberration to the emitted laser beam. From the simplest optical consideration, it is understood that a single cylindrical lens can correct astigmatism aberration of an emitted laser beam. Therefore, one astigmatic aberration of the light beam can be corrected with an opposite astigmatism of another lens.

FIG. 6 shows three cases of utilizing a glass plate as described by Matsui to correct the laser beam astigmatism. The ray tracings as illustrated in FIG. 6 are simulated by the DEMOS optical program made by the S.I. Vavilov State Optical Institute in Russia. The optical plate 60 is positioned after the laser diode 42 and placed in the path of the divergence beam. FIGS. 6A, 6B, and 6C show the three cases when the plate 60 is positioned a different distance L or 2L away from the laser diode 42 and configured at different tilt angles δ=0° or 10° with respect to the optical axis of the system. FIGS. 7A, 7B, and 7C show the calculated aberration data of those systems shown in FIGS. 6A, 6B, and 6C, respectively, based on the assumption that the laser diode 42 produces an ideal divergence beam with a spherical wave front. The calculations were performed based on the further assumption that the three systems shown in FIGS. 6A, 6B, and 6C each produce an illumination area of equal size at some plane 62 away from the optical plate 60.

As seen from the data provided in FIGS. 7A, 7B, and 7C, the optical plate 60 introduces different aberrations except astigmatism. Therefore, it is clear that the introduction of a glass plate, whether vertical or tilted, in any system brings forth significant distortion in optical quality. Furthermore, the method and results described by Matsui is extremely difficult to execute and realize. In practice, mechanical and aligning difficulties exist because even the slightest-of-all tolerances are very important in the field of optics. Although astigmatism can be corrected with an opposite astigmatism of another lens, tilting of the cylindrical lens introduces other aberrations that cannot be compensated. Another disadvantage of the Matsui system is that the emitted laser beam is too small in size (about 1 mm). As mentioned above, such a narrow laser beam with a high optical power density poses serious dangers in the event of accidental ocular exposure.

Also widely employed in laser applications are two lens (mirrors as well) telescope (afocal) expanders that are not of anamorphic types and therefore emit laser beams that are non-circular in shape. Other usual lens systems (i.e., those that are non-anamorphic and having no tilted lens) cannot correct laser beam astigmatism. As described above, various attempts have been made to address the issue of astigmatic aberration of an emitted laser beam, but none have effectively dealt with the problem.

### SUMMARY OF THE INVENTION

In accordance with the teachings of the present invention, an anamorphic optical collimator for laser diode having 5-lens elements of positive, positive, negative, positive, and positive optical power provides an input aperture angle of up to ±22° in its meridianal section and up to ±6° in its sagittal section, a large exit pupil, anamorphic coefficient equal to 4, an angular divergence of collimated beam not exceeding 1 mrad, and the possibility of independently adjusting the angular divergences of the exit laser beam in the meridianal and sagittal planes of the optical collimator.

According to an embodiment of the invention, the optical collimator comprises a first positive spherical lens element of a meniscus shape with its concave surface faced to laser diode, a second positive spherical lens element of a plane-convex shape, a third negative cylindrical lens element of a plane-concave shape, a fourth positive cylindrical lens element of a plane-convex shape, and a fifth positive lens element of a spherical plane-convex shape. The first three lens elements are mounted in a housing that may move along and rotate about the collimator's optical axis. This rotation allows the third lens element to rotate relative to the fourth lens element such that the angular divergence of the exit laser beam with respect to its meridianal and sagittal planes of the collimator may be independently adjusted. The exit pupil size of the optical collimator is chosen so as to provide a safe operating range of optical power densities with respect to the human eyes in cases of ocular exposure, even when the laser diode generates a beam with laser power as high as 100 mW. Furthermore, the optical collimator of the present invention minimizes beam aberration as much as possible while providing a collimated beam with an angular divergence of less than 1 mrad.

A more complete understanding of the anamorphic optical collimator for laser diode will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 illustrates a principal optical scheme of a prior art two-prism shaper of a laser diode beam (meridianal section);

FIG. 2 illustrates a principal optical scheme of a prior art two-prism shaper of a laser diode beam (sagittal section);

FIG. 3A illustrates the cross section of a laser beam before the prior art two-prism shaper of FIG. 1;

FIG. 3B illustrates the cross section of a laser beam between the prior art two-prism shaper of FIG. 1;

FIG. 3C illustrates the cross section of a laser beam after the prior art two-prism shaper of FIG. 1;

FIG. 4A illustrates a principal optical scheme of a prior art collimator with a two-prism shaper (meridianal section);

FIG. 4A illustrates a principal optical scheme of a prior art collimator with a two-prism shaper (sagittal section);

FIG. 5 illustrates the astigmatic performance of a laser diode collimator;

FIG. 6A illustrates the optical rays tracings from a point source through a vertical glass plate (prior art);

FIG. 6B illustrates the optical rays tracings from a point source through a tilted glass plate (prior art);

FIG. 6C illustrates the optical rays tracings from a point source through another tilted glass plate (prior art);

FIG. 7A is a table providing the calculated aberration data of the system shown in FIG. 6A;

FIG. 7B is a table providing the calculated aberration data of the system shown in FIG. 6B;

FIG. 7C is a table providing the calculated aberration data of the system shown in FIG. 6C;

FIG. 8A is a sectional view of the laser collimator of the present invention;

FIG. 8B is a detailed view of the first three lenses of the laser collimator of FIG. 8A;

FIG. 9A illustrates the optical scheme of the collimator of the present invention (meridianal plane);

FIG. 9B illustrates the optical scheme of the collimator of the present invention (sagittal plane);

FIG. 10 is a table providing the exact optical data of the collimator of FIG. 8A;

FIG. 11 is a table providing the main optical parameters and the components for the meridianial plane of the collimator of FIG. 8A;

FIG. 12 is a table providing the main optical parameters and the components for the sagittal plane of the collimator of FIG. 8A;

FIG. 13A illustrates the shape of the laser beam as it appears on the second optical surface of the collimator of FIG. 8A;

FIG. 13B illustrates the shape of the laser beam as it appears on the seventh optical surface of the collimator of FIG. 8A;

FIG. 13C illustrates the shape of the laser beam as it appears on the ninth optical surface of the collimator of FIG. 8A;

FIG. 13D illustrates the shape of the laser beam as it appears on the eleventh optical surface of the collimator of FIG. 8A;

FIG. 14 is a table providing the data of the clear optical apertures of the lenses and the shape of the beam of the collimator of FIG. 8A;

FIG. 15 is a table providing the data for laser power density at various points away from the beam source for the collimator of FIG. 8A;

FIG. 16A illustrates optical beams tracings within a distance of 1 km with the lenses of the collimator of FIG. 8A positioned in one way;

FIG. 16B illustrates optical beams tracings within a distance of 1 km when the lenses of the collimator of FIG. 8A are positioned in another way;

FIG. 17 illustrates the reflectivity of lens surfaces with anti-reflective (AR) coating;

FIG. 18 is a three-dimensional plot of a geometrical point spread function of the collimator of the invention; and

FIG. 19 is a table providing the aberration data of the collimator of FIG. 8A.

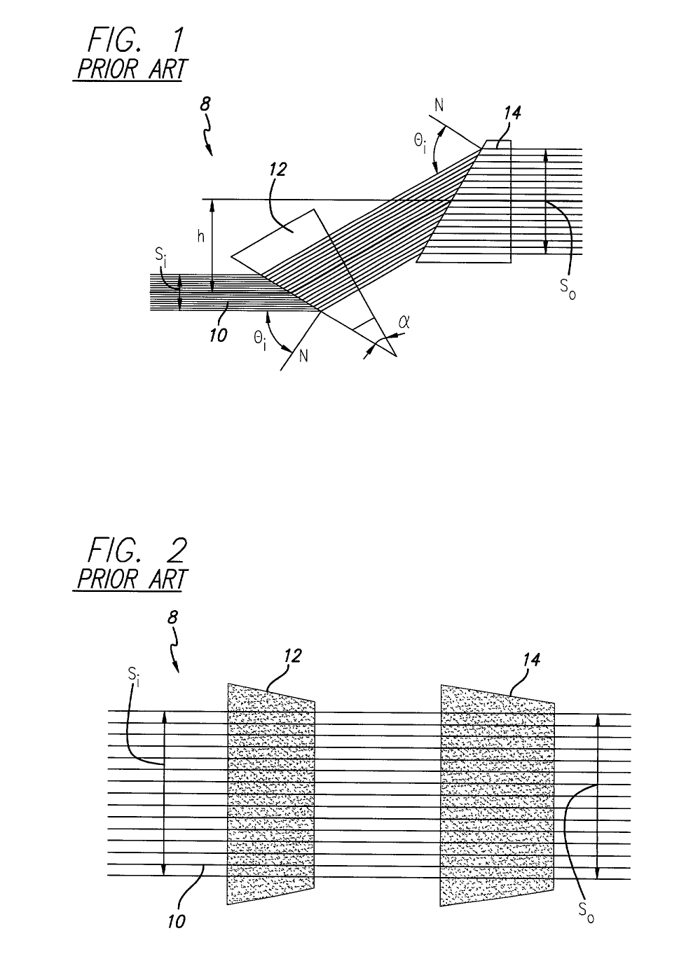

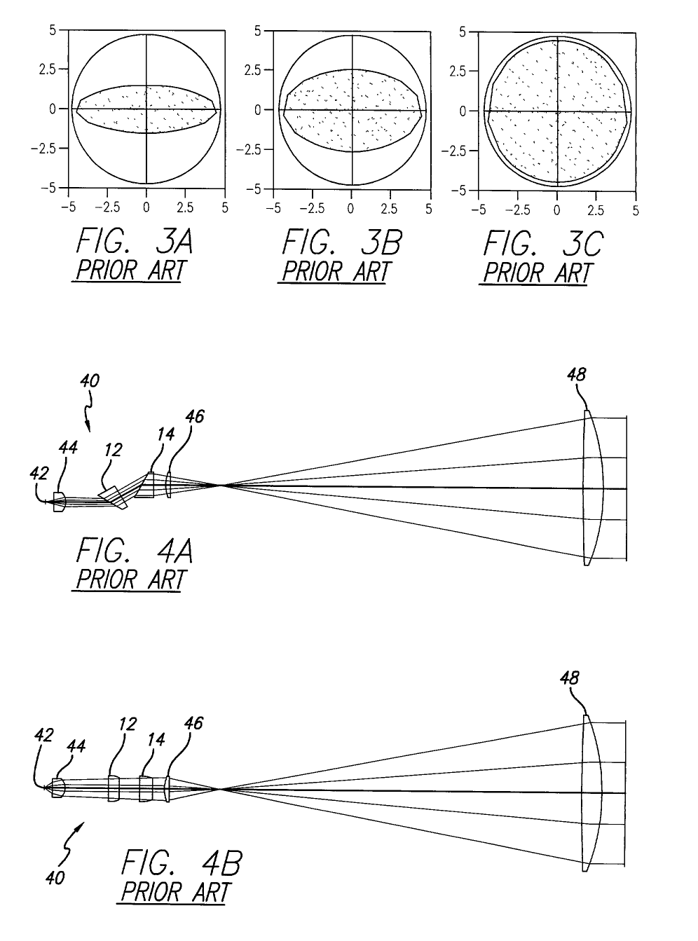

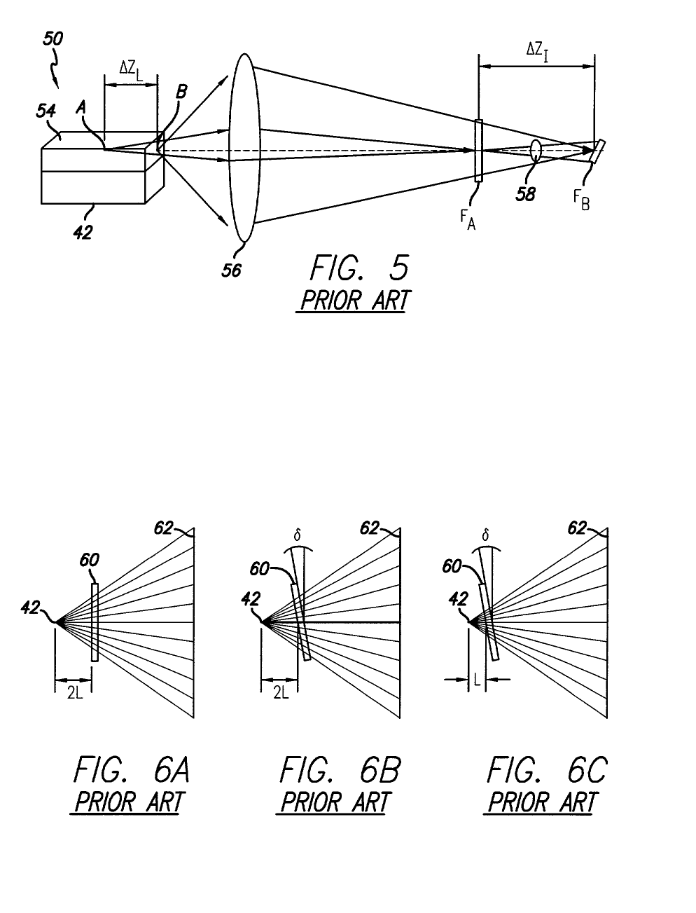

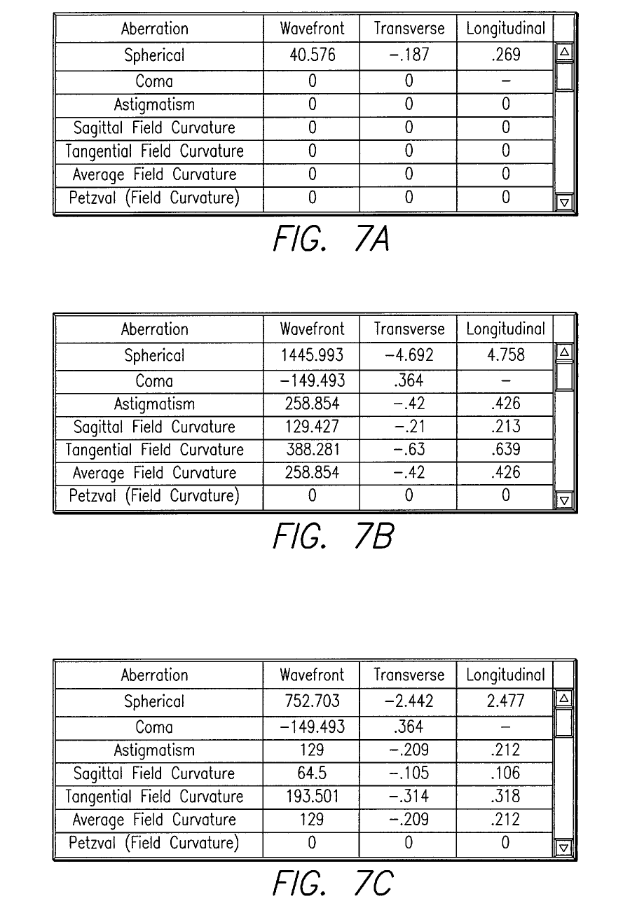

### DETAILED DESCRIPTION OF THE PREFERRED EMBODIMENT

The present invention is directed to a laser diode beam collimator for use in applications where laser beams must be transmitted within a narrow physical band without much angular divergence and safely without causing eye injuries even in the event of direct human ocular exposure. The laser diode collimator of the present invention overcomes the abovementioned drawbacks of prior art systems and provides a feasible solution of utilizing laser beams in a wireless optical data communication network. In the detailed description that follows, like element numerals are used to describe like elements illustrated in one or more of the figures.

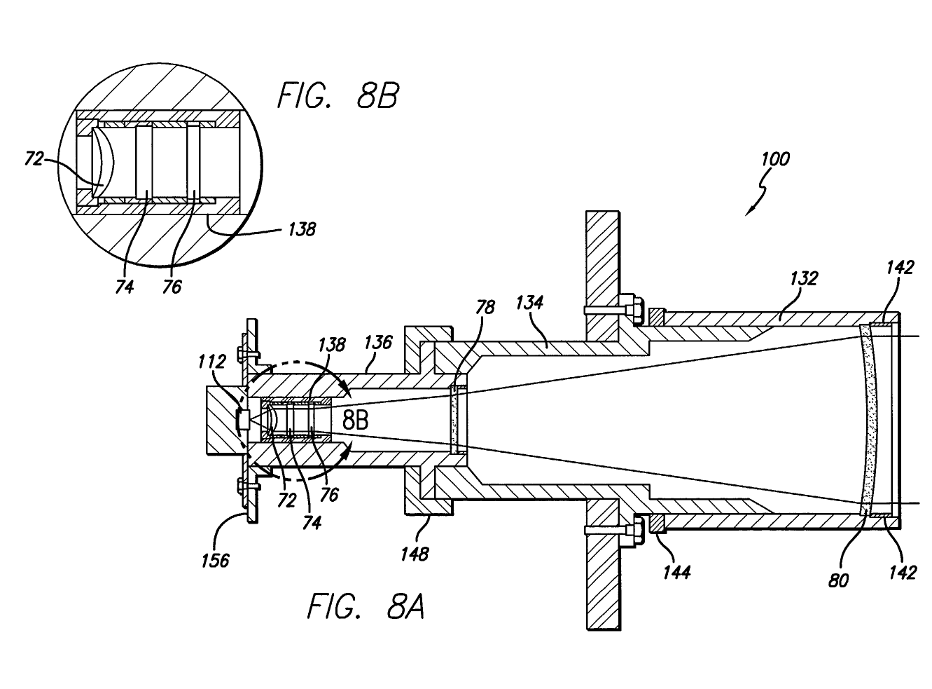

An exemplary structure of the 5-lens laser collimator 100 of the present invention is illustrated in FIG. 8A. The lens positions and their dimensions are shown for the meridianal section of the collimator where the laser diode emits a wider beam. The first three lenses 72, 74, and 76 of the collimator 100 are mounted inside the metal housing 138. A more detailed view of the lenses 72, 74, and 76 along with the metal housing 138 is provided in FIG. 8B. That metal housing 138 is aligned and integrated as one unit of the collimator and is enclosed within case 136. The design of the collimator 100 is unique in that it allows the housing 138 to move along the collimator's optical axis and also rotate within the case 136. Similarly, the case 136 is able to rotate along the optical axis of the collimator with respect plate 156, which support the laser diode 112.

Therefore, with the rotation of the case 136, it is possible to properly orient the elliptically shaped laser beam coming from the laser diode 112 with the orientation of the two cylindrical lenses 76 and 78. This design first allows the cylindrical lenses 76 and 78 to be set mutually in order to minimize the aberration of the collimator. Secondly, it now becomes possible to change the optical power of the collimator in the sagittal plane and therefore makes it is possible to change a divergence of the exit beam in this plane. Thus, the angular divergence of the exit laser beam with respect to its meridianal and sagittal planes of the collimator can be independently adjusted. Simultaneously, the initial laser beam's astigmatism can be easily and completely corrected. It is very important that changes of total optical power of the cylindrical lenses 76 and 78 do not influence and affect the optical power of the collimator in the meridianal plane.

After the optical collimator is aligned, the housing 138 and case 136 are assembled together and joined. Similarly, the case 136 in turn is joined to case 134 by a screw ring 148. The lens 80 is mounted inside the housing 132 having an inner screw 142 on the side opposite the lens. The housing 132 with the lens 80 can then be moved along the main case 134 in order to change the divergence of the beam exiting the collimator. The movement of that lens 80 changes the divergence of the laser beam simultaneously in the meridianal and sagittal planes and does not affect the shape of illuminating spot nor the laser beam astigmatism. When all of the collimator's lenses are optically aligned, the main case 134 and the housing 132 are joined by the screw ring 144.

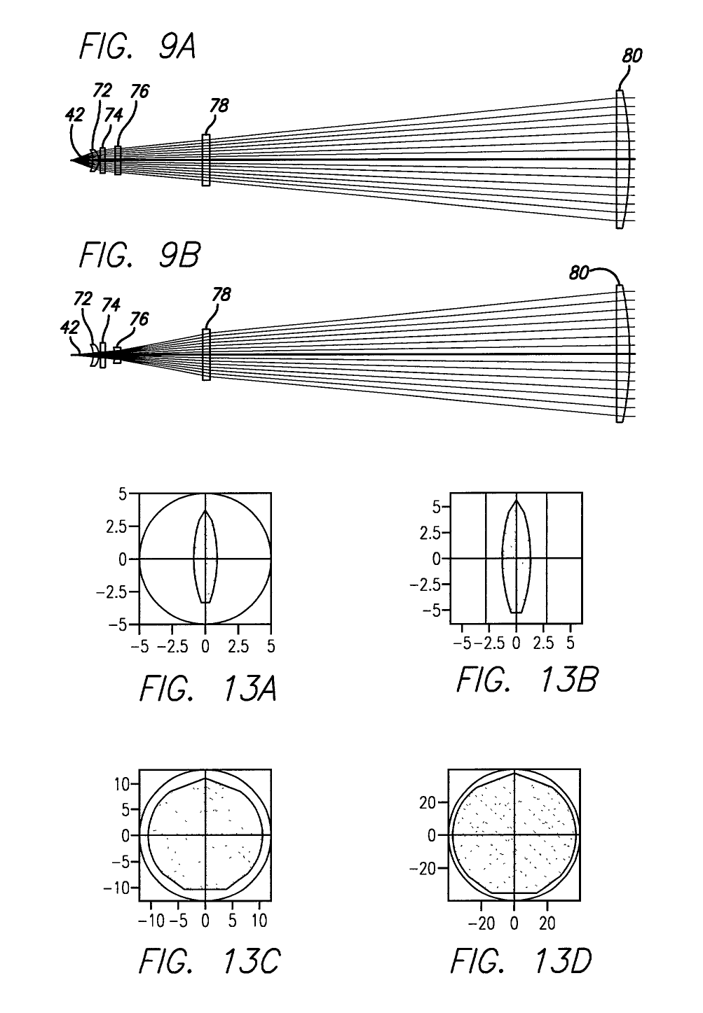

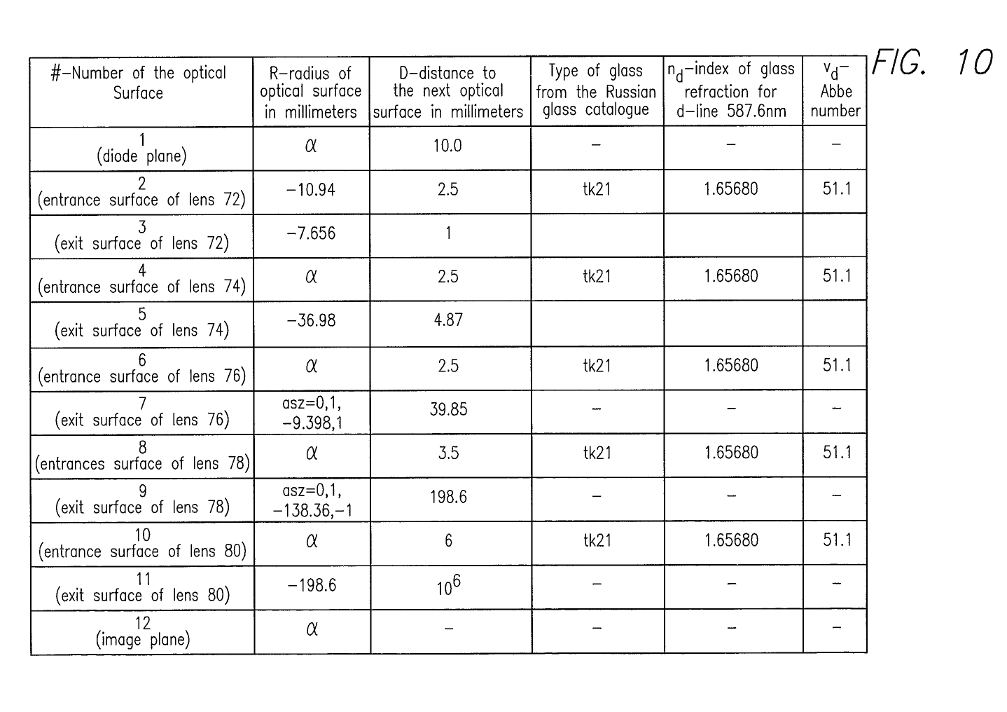

An optical scheme of the 5-lens laser collimator 100 of FIG. 8A in its meridianal and sagittal planes is depicted in FIGS. 9A and 9B, respectively. The collimator is designed with its input angular aperture equal to ±22.21° in the meridianal plane and ±5.320 in the sagittal plane. Therefore, the aperture values are large enough to accommodate and accept light from most laser diodes producing emitting beams with an angular lobe of about 30-40°×8-10°. The first two lenses 72 and 74 of the subject collimator function as spherical lenses contributing to a high input aperture and a minimal amount of spherical aberration on the whole. Lens 72 is a positive spherical lens of a meniscus shape with its concave surface facing the laser diode. The second positive spherical lens 74 is of a plane-convex shape. A second pair of lenses 76 and 78 of the subject collimator are cylindrical lenses. These second pair of lenses shape and trim the emitted laser beam in both the meridianal and sagittal planes. Lens 76 is a plane-concave negative lens while lens 78 is a plane-convex positive lens. Finally, the collimating lens 80 is a plane-convex spherical lens. The exact optical data of the collimator's lenses are shown in FIG. 10.

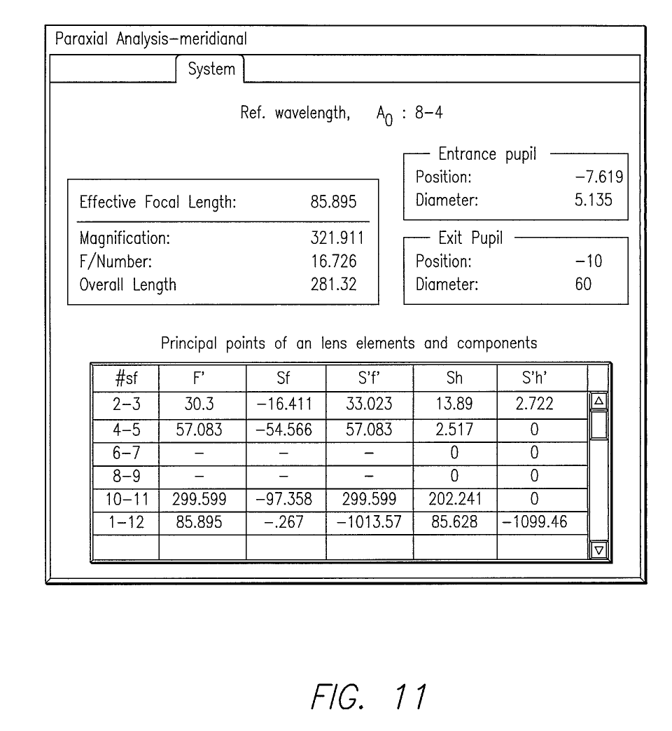

The main optical parameters of the collimator and its components for the meridianal plane are provided in FIG. 11. All of the notations that appear in FIG. 11 below are the standard notations used in the described optical systems. Similarly, the main optical parameters of the collimator and its components for the sagittal plane are provided in FIG. 12. From the data of FIGS. 11 and 12, it can be seen that a difference in focal lengths of the collimator exists for the cross sections. FIGS. 11 and 12 show the effective focal distance F′ for each optical component of the collimator 100. For example, F′=30.3 mm for the first lens 72, as indicated by optical surfaces 2 through 3 of FIGS. 11 and 12. Likewise, F′=57.083 mm for the second lens 74 having optical surfaces 4 through 5. F′=85.895 mm and 438.487 mm are the effective focal lengths for the entire collimator 100 (optical surfaces 1 through 12). The difference in F′ in the meridianal and sagittal planes for the entire collimator 100 (optical surfaces 1 through 12) indicates that the collimator 100 is an anamorphic optical system.

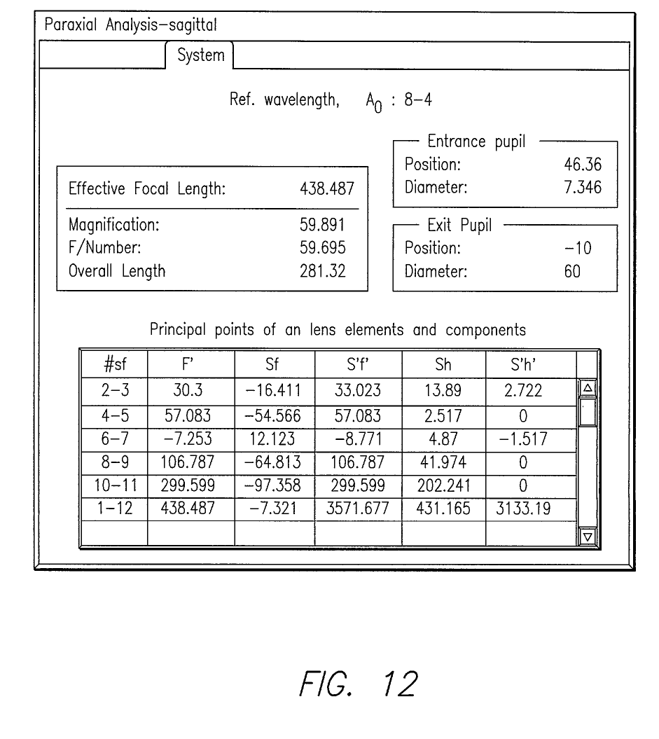

FIGS. 13A, 13B, 13C, 13D show the shape of laser beam as it appears on the optical surfaces of the different lenses (i.e., one of the five lenses) of the collimator in sequential order. FIG. 13A shows the shape of the laser beam at optical surface #2 (i.e., entrance surface of lens 72); FIG. 13B shows the shape of the laser beam at optical surface #7 (i.e., exit surface of lens 76); FIG. 13C shows the shape of the laser beam at optical surface #9 (i.e., exit surface of lens 78); FIG. 13D shows the shape of the laser beam at optical surface #11 (i.e., exit surface of lens 80).

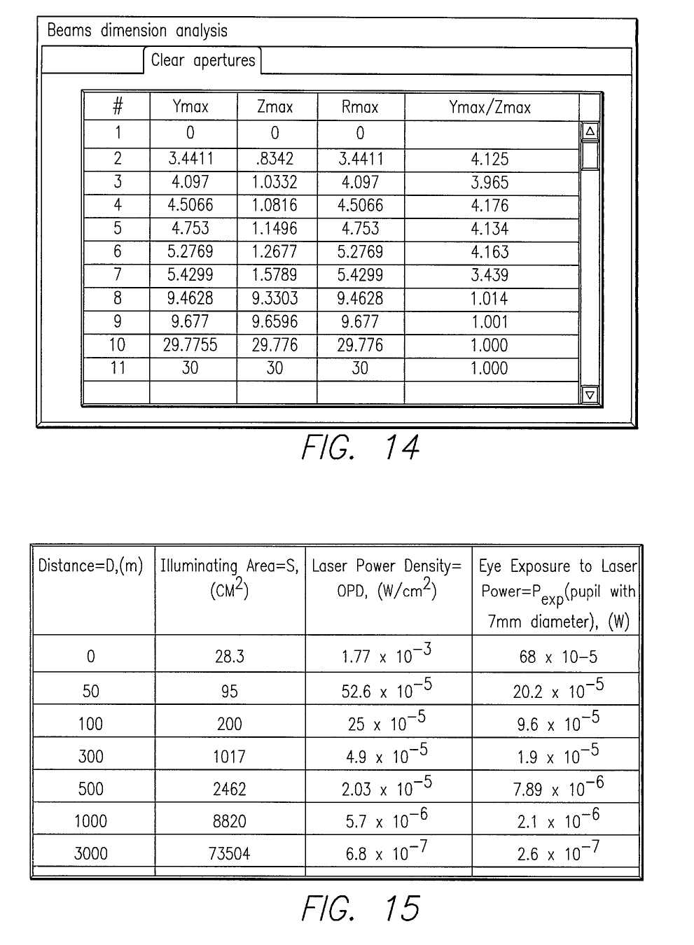

Referring back to FIGS. 9A and 9B, although the original laser beam emitted from the laser diode is in an elliptical shape, by the time the beam exits the fifth lens 80 of the collimator, it has changed to nearly a circular shape. Therefore, the anamorphic performance of the collimator properly corrects the shape of the laser beam. The data concerning the clear optical apertures of the lenses Yₘₐₓ (meridianal section), Zₘₐₓ (sagittal section) and concerning the shape of the beam Yₘₐₓ/Zₘₐₓ is provided in FIG. 14. From the data of FIG. 14, it can be seen that the input laser beam having an elliptical shape (Yₘₐₓ/Zₘₐₓ=4.125) is converted to a beam with a circular shape (Yₘₐₓ/Zₘₐₓ=1.000) and a radius equal to 30 mm.

The size of the collimator's pupil was chosen to measure 60 mm in diameter to reduce the optical power density of the beam, to reduce random interference of atmospheric particles (e.g., snow, rain, etc.) as the laser travels through free space (i.e., in a wireless optical data communication system applications), and to reduce the divergence of the collimated beam.

The near infrared (IR) laser diodes with an optical power P of up to 100 mW are usually applied in most wireless optical data communication systems. However, because amplitude modulation is used in laser driving, a laser beam may be considered to be emitted only one-half of the time, since the probability of “one” and “zero” pulses may be assumed to be equal. Assuming for sake of simplicity that a uniform optical power distribution exists in the exit pupil having a diameter of 6 cm and square S=28.3 cm² along with no optical loss in the collimator, the maximal optical power density (OPD) inside the laser beam can be expressed as:

OPD=P/S=0.05 W/28.3 cm²=0.00177 W/cm² (3)

Consider the worst case scenario of direct ocular exposure of some person who accidentally catches the laser beam having a divergence of 1 mrad directly in the eye. For example, given that the area of a human eye with a pupil diameter of 7 mm is 0.385 cm², the power of exposure Pₑₓₚ to this eye near the optical collimator can be expressed as:

Pₑₓₚ=0.00177 W/cm²×0.385 cm²=0.00068 W (4)

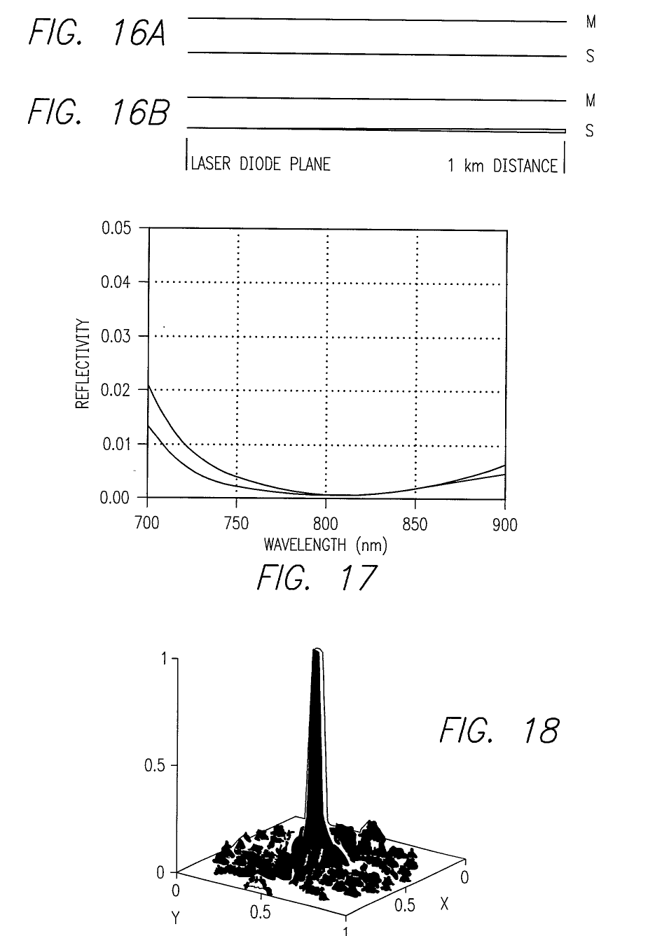

With the 1 mrad laser beam divergence, the values can be calculated for the illuminating area S, OPD, and Pₑₓₚ at several points away from the optical collimator. These results are provided in FIG. 15.

For continuous wave (CW) lasers and laser systems, according to ANSI Z136.1-1993, the maximum value of laser power tolerable for human eye exposure is set at a value less than or equal to:

MPE (maximum permissible exposure)≦128 C_{A}×10⁻⁶ W (5)

C_{A} represents the correction factor which increases the MPE values in the near infrared spectral band (e.g., for wavelengths of light in the range of 700-1400 nm) based upon reduced absorption properties of melamin pigment granules found in the retinal pigment epithelium. The value defined by equation (5) is an estimated value based on an exposure of long duration equal to 3×10⁴ seconds (i.e., over 8 hours in duration). If exposure time does not exceed 10 seconds, then the value defined by (5) can be further increased significantly.

The factor CA is given exactly [see FIG. 8a of ANSI Z136.1-1993] and equals 1.6 for 800 nm wavelength radiation and equals 3 for 930 nm wavelength radiation. Therefore, from equation (5) the MPE equals:

20.5×10⁻⁵ W (6)

for radiation with 800 nm wavelength, and

30.8×10⁻⁵ W (7)

for radiation with 930 nm wavelength.

As it follows from comparison of data from FIG. 15 and data from equations (6) and (7), for exposures from distances greater than 100 m, there is no danger of injuring the human eye (i.e., case of intrabeam viewing with a naked eye). This characteristic allows using the optical collimator of the present invention even in a urban environment. Using the same data, it is also possible to estimate and determine safety guidelines for conditions in which a reflective or a focusing optical element may come across the path of the transmitted laser beam. However, as long as the interference element is not a focusing element such as a spherical mirror or a binocular lens having a large entrance aperture, then there is little risk of danger to being exposed beyond the MPE value.

Another advantage of having a collimator with a large exit pupil is the reduction in statistical noise for the transmitted laser beam. When atmospheric particles cross the path of the transmitted laser beam, the optical power inside the beam changes. Since the size of laser beam exiting the collimator is at least 6 cm in diameter, the influence of the small atmospheric particles such as snow and droplets of rain have very little disturbance effects. Yet another advantage of having a collimator with a large exit pupil is the possibility of reducing the divergence of the collimated beams. This principle of optical law is usually referred to as “the optical invariant” [see example in book Max Born, Emil Wolf “Principles of Optics”, Pergamon Press, 1964].

One further advantage of the laser collimator of the present invention is the capability of precisely correcting the astigmatism of the laser beam. It is possible to independently change the optical power OP of the collimator for the meridianal and sagittal planes (OP=1/F, where F is a focal distance of the collimator for meridianal or sagittal planes) by changing the distance between the two cylindrical lenses 76 and 78. The two sets of optical beam tracings of FIGS. 16A and 16B provide more detail. The first pair of lines of FIG. 16A depict laser beam tracings at a distance of 1 km away from a collimator that has its lenses positioned according to the data given in FIG. 10. M and S specify the tracings for the meridianal and sagittal planes, respectively. The angular divergence of the beam is about ±0.3 mrad. The second pair of lines of FIG. 16B depict the beam tracings when the distance of optical surface D₇ is 43 mm instead of 39.85 mm, and the distance of optical surface D₉ is 196 mm instead of 198.6 mm. In this case, the laser beam has different divergences in its meridianal M and sagittal S planes. Although these different beam divergences indicate that the beam has become astigmatic, the cylindrical lenses of the collimator can be properly positioned to cure this astigmatism. When optically aligning the collimator, the distance between the cylindrical lenses of the collimator can be chosen to compensate for the initial astigmatism of the emitted laser beam. The necessary position of the lenses 78 and 80 as shown in FIGS. 9A and 9B can be easily determined with a commercially available computer program such as DEMOS made by the S.I. Vavilov State Optical Institute in Russia. In addition, both positive and negative astigmatic differences can be compensated. This type of performance enables the collimator of the present invention to produce a laser beam with a circular area of illumination from various laser diodes with different astigmatic characteristics.

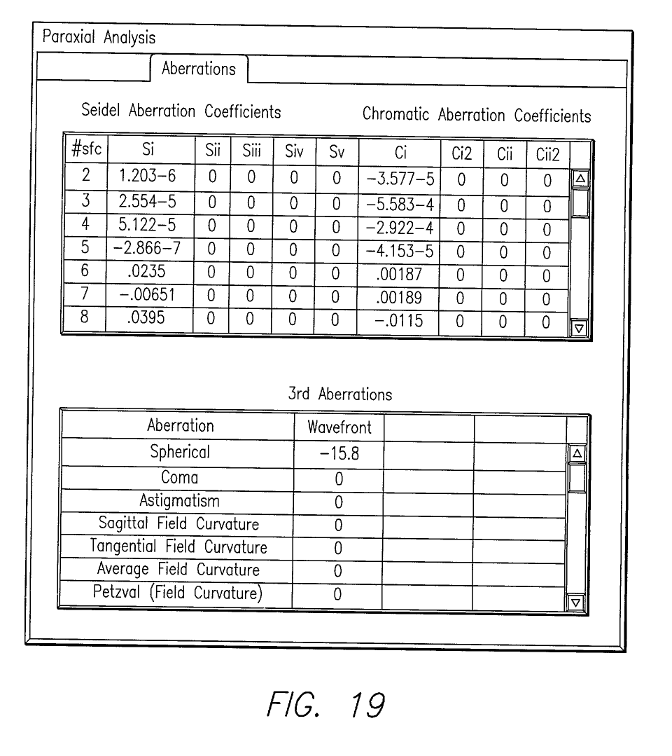

The laser collimator's symmetry with respect to its optical axis is yet another advantage of the present invention. Compared with the two-prism shapers, the symmetry of the subject collimator enables a more efficient manufacturing process. For example, since its lens housings are easier to manufacture, it reduces costs attributable to mechanical details, while at the same time increasing available tolerances. It is also easier to optically align the collimator. Since AR lens coatings are also more easily produced with better performance, loss of optical power is significantly reduced. Measured reflectivity of non-polarized light for a sample lens surface is shown in FIG. 17.

Referring to FIG. 17, it can be seen that the minimum reflectivity of the lens surface is about 0.001=0.1% for a 810 nm working wavelength light of the laser diode. The collimator 100 has 5 lenses with AR coatings. If the reflectivity of any lens surface is noted as R, the transparency of one particular lens is:

T₁=(1−R)·(1−R) (8)

Since the absorption of the lens glass is small, it is not considered. The total transparency of the 5-lens collimator 100 is therefore equal to (T₁)⁵. If the reflectivity of the AR coating is 0.001, for example, then T₁=0.998 and (T₁)⁵=0.998⁵=0.99. This means that the minimal reflective loss inside the collimator is 0.01 or 1%. If the laser wavelength is not matched exactly with 810 nm, then the loss will increase. For example, as it follows from the graph of FIG. 17, for 900 nm wavelength, R=0.005, T₁=0.99 and the total power loss amount to about 5%. Therefore, the optical power loss in the collimator of the present invention can be estimated to be about a few percent (e.g., 3%). This figure is significantly less than that of prior art collimators having a two-prism shaper.

Angular divergence of the output beam is one of the most important concerns for a laser collimator used in a wireless communication system. Theoretically, it is preferable to use a beam with as small of a divergence as possible since such a beam will increase the optical signal for the detector. Currently, free space laser communication systems utilize laser beams with several tens of angular seconds divergence [see Isaac I. Kim, et. al., “Horizontal-Link Performance of the STRY-2 Lasercom Experiment Ground Terminals”, Proc. of SPIE, vol.3615, “Free-Space Laser Communication Technologies XI”, pp. 11-22, 1999]. However, different ground wireless communication systems usually use laser beams with 1-30 mrad of angular divergence [see Isaac I. Kim, et. al “Wireless Optical Transmission of Fast Internet, FDDI, ATM, and ESCON Protocol Data Using TerraLink Laser Communication System”, Optical Engineering, 37(12), pp. 3143-3155 (December 1998)]. If a laser collimator has a high optical performance, then the choice of the divergence angle of the transmitted beam is grounded mainly on the mechanical stability of the communication device, taking into account the natural movement of buildings and other things on which the system may be mounted. For example, the daily motion of building walls contribute to the laser beams to swinging 0.25-0.30 mrad). Atmospheric turbulence also contributes to the wandering of the laser beam. [see Larry C. Andrews, Ronald L. Phillips, “Laser Beam Propagation Through Random Media, SPIE Optical Engineering Press]. All these parameters together define a possibility of stable position laser beams within the receiver lens apertures of communicating devices. The laser collimator of the present invention allows making the minimal 0.9 mrad of total divergence. Therefore, a focused spot with a 90 cm radius is available at a distance of 1 km away from the point of emission. This specification make such a laser beam suitable for usage in a ground wireless communication system. The point-spread function of the collimator is shown in FIG. 18 (3-D plot).

An aberration analysis of the laser collimator and the picture of the point-spread function of FIG. 18 show that light distribution inside a focused spot is defined primarily by the spherical aberration of the collimator. Data concerning the aberrations of the collimator are provided in FIG. 19. It should be noted that only spherical aberration exists (its value is noted in a number of wavelengths). Although all of the above noted data were related to 800 nm wavelength light, the collimator displays similar parameters for 1.5 μm wavelength light.

Having thus described a preferred embodiment of the 5-lens laser collimator, it should be apparent to those skilled in the art that certain advantages have been achieved. It should also be appreciated that various modifications, adaptations, and alternative embodiments thereof may be made within the scope and spirit of the present invention. The invention is further defined by the following claims.

What is claimed is:

1. An anamorphic optical collimator, comprising:
a laser diode; and
a plurality of successive lens elements coupled to said laser diode comprising:
a first positive spherical lens element of a meniscus shape having a concave surface facing said laser diode;
a second positive spherical lens element having a plane-convex shape;
a third negative cylindrical lens element having a plane-concave shape;
a fourth positive cylindrical lens element having a plane-convex shape; and
a fifth positive lens element having a spherical plane-convex shape.

2. The anamorphic optical collimator of claim 1, wherein said first, second, and third lenses are mounted inside a metal housing, said metal housing aligned and integrated as one unit of said collimator and enclosed within a case.

3. The anamorphic optical collimator of claim 2, wherein said metal housing moves along and rotates about an optical axis of said collimator.

4. The anamorphic optical collimator of claim 3, wherein said case rotates along said optical axis with respect to a plurality of plates supporting said laser diode.

5. The anamorphic optical collimator of claim 4, further comprising an input aperture angle from a side facing said laser diode of up to ±22° in its meridianal section and up to ±6° in its sagittal section.

6. The anamorphic optical collimator of claim 5, wherein an optical parameter of each said spherical lens elements is selected to minimize a spherical aberration of said collimator.

7. The anamorphic optical collimator of claim 6, wherein an optical parameter of each said cylindrical lens elements is selected to minimize a spherical aberration of said collimator.

8. The anamorphic optical collimator of claim 5, further comprising an exit pupil having a sufficiently large diameter to prevent eye injuries in an accidental ocular exposure of high optical power.

9. The anamorphic optical collimator of claim 4, wherein an angular divergence of a collimated beam emitted from said laser diode does not exceed 1 mrad.

10. A method of collimating a laser beam, comprising the steps of:
emitting said laser beam from a laser diode; and
transmitting said laser beam through a plurality of successive lens elements further comprising the steps of aligning said emitted laser beam to correspond with an orientation of a plurality of cylindrical lenses among said successive lens elements.

11. The method of claim 10, further comprising the step of mutually setting said cylindrical lenses to minimize an aberration of said emitted laser beam.

12. The method of claim 11, further comprising the step of changing an angular divergence of said emitted laser beam in a sagittal plane.

13. The method of claim 12, further comprising the step of independently adjusting the angular divergence in said sagittal plane and a meridianal plane.

14. A system for collimating a laser beam, comprising:
means for emitting said laser beam from a laser diode; and
means for transmitting said laser beam through a plurality of successive lens elements further comprising means for aligning said emitted laser beam to correspond with an orientation of a plurality of cylindrical lenses among said successive lens elements.

15. The method of claim 14, further comprising means for mutually setting said cylindrical lenses to minimize an aberration of said emitted laser beam.

16. The method of claim 15, further comprising means for changing an angular divergence of said emitted laser beam in a sagittal plane.

17. The method of claim 16, further comprising means for independently adjusting said angular divergence in said sagittal plane and a meridianal plane.
